(19) United States
(12) Patent Application Publication
(10) Pub. No.: US 2010/0117601 A1
(43) Pub. Date: May 13, 2010

(54) DEVICE FOR REVITALIZING BATTERY AND ENHANCING IGNITION PERFORMANCE

(76) Inventor: Linming Liu, Taipei City (TW)

Correspondence Address: LEONG C LEI, PMB # 1008, 1867 YGNACIO VALLEY ROAD, WALNUT CREEK, CA, 94598, US

(21) Appl. No.: 12/269,898

(22) Filed: Nov. 13, 2008

(51) Int. Cl. H02J 7/00

(52) U.S. Cl. 320/139

(57) ABSTRACT

The device contains a pulse generation circuit, a frequency generation circuit, a voltage detection circuit, and a frequency control circuit. A positive terminal of a lead-acid battery of a motor vehicle is connected to the pulse generation circuit and the voltage detection circuit. The pulse generation circuit is connected to the positive terminal of the battery, the frequency generation circuit, and the frequency control circuit. The frequency generation circuit is connected to voltage detection circuit, the frequency control circuit, and the pulse generation circuit. The voltage detection circuit is connected to the positive terminal of the battery, the frequency generation circuit, and the frequency control circuit. The frequency control circuit is connected to the voltage detection circuit, the frequency generation circuit, and the pulse generation circuit.

### TECHNICAL FIELD OF THE INVENTION

The present invention generally relates to devices for improving a motor vehicle's performance, and more particularly to a device capable of revitalizing lead-acid battery and enhancing the ignition performance of a motor vehicle simultaneously.

### DESCRIPTION OF THE PRIOR ART

A conventional method to revitalize a lead-acid battery commonly found on a motor vehicle is to apply high-frequency pulses to the battery so as to electronically dissolve sulfation formations on the electrode plates of the battery back into the electrolyte solution. For example, U.S. Pat. No. 3,727,071 teaches such a technique. However, the 071 patent cannot tell what is the best frequency and power of the pulses for the battery and therefore applies pulses of a preset frequency. As such, it is quite often that the battery never gets revitalized or the battery is actually damaged and aging even faster.

On the other hand, a motor vehicle's ignition performance is highly related to the fuel economy of the engine of the motor vehicle. In addition to applying pulses to revitalize the motor vehicle's battery, if the pulses are superimposed on the direct-current voltage of the motor vehicle's battery, the ignition performance of the motor vehicle's engine could be enhanced as well.

### SUMMARY OF THE INVENTION

A device for simultaneously revitalizing the battery and enhancing the ignition performance of a motor vehicle is provided herein. The device contains a pulse generation circuit, a frequency generation circuit, a voltage detection circuit, and a frequency control circuit.

The pulse generation circuit is connected to a positive terminal of a lead-acid battery of the motor vehicle, the frequency generation circuit, and the frequency control circuit.

The frequency generation circuit is connected to the voltage detection circuit, the frequency control circuit, and the pulse generation circuit.

The voltage detection circuit is connected to the positive terminal of the battery, the frequency generation circuit, and the frequency control circuit.

The frequency control circuit is connected to the voltage detection circuit, the frequency generation circuit, and the pulse generation circuit.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram according to the present invention.

FIG. 2 is a circuit diagram showing a device according to an embodiment of FIG. 1.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

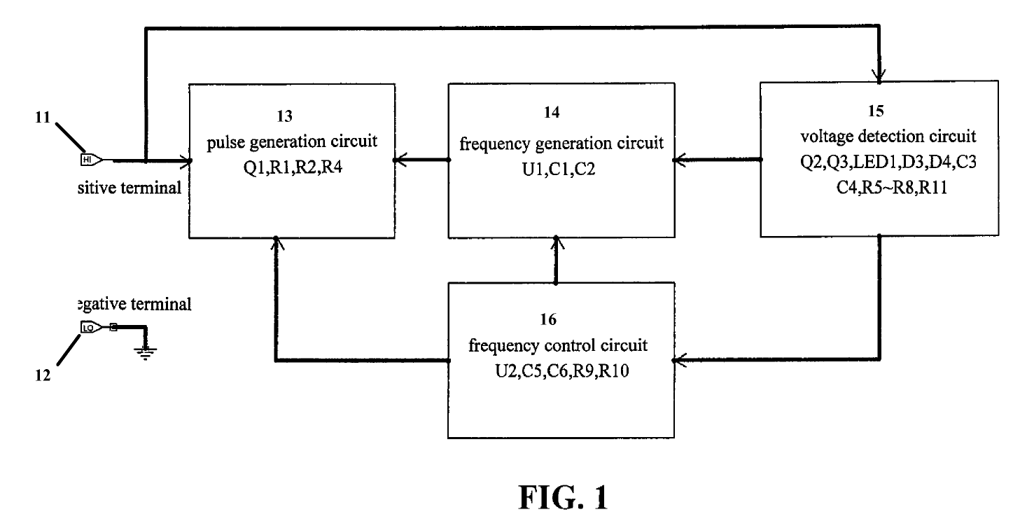

As shown in the functional block diagram of FIG. 1, a device according to the present invention contains a pulse generation circuit 13, a frequency generation circuit 14, a voltage detection circuit 15, and a frequency control circuit 16. A positive terminal 11 of a lead-acid battery of a motor vehicle is connected to the pulse generation circuit 13 and the voltage detection circuit 15. A negative terminal 12 of the lead-acid battery is connected to ground. In addition to the positive terminal 11, the pulse generation circuit 13 is also connected to the frequency generation circuit 14 and the frequency control circuit 16. The frequency generation circuit 14, on the other hand, is connected to the voltage detection circuit 15 and the frequency control circuit 16, in addition to the pulse generation circuit 13. The voltage detection circuit 15 is connected to the positive terminal 11 of the battery, the frequency generation circuit 14, and the frequency control circuit 16. The frequency control circuit 16 is connected to the voltage detection circuit 15, the frequency generation circuit 14, and the pulse generation circuit 13.

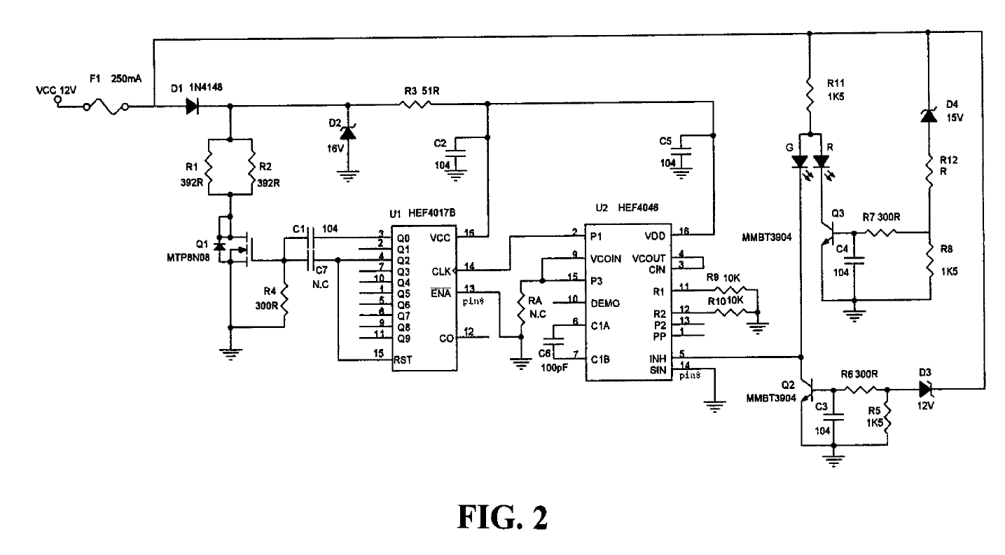

As shown in FIG. 2, the pulse generation circuit 13 contains resistors R1, R2, R4, and a triode Q1. The frequency generation circuit 14 contains an integrated circuit U1, and capacitors C1, C2. The voltage detection circuit 15 contains triodes Q2, Q3, a light emitting diode LED1, diodes D3, D4, resistors R5 to R8, R11 and capacitors C3, C4. The frequency control circuit 16 contains an integrated circuit U2, capacitors C5, C6, and resistors R9, R10.

The operation principle of the device is as follows. When the voltage detection circuit 15 senses the voltage from the positive terminal 11 of the battery to be higher than a pre-determined threshold, it activates the frequency control circuit 16 to produce an oscillation frequency (which is controllable by voltage). The oscillation frequency is then used by the frequency generation circuit 14 to produce pulses of the desired frequency. The pulses are passed to the pulse generation circuit 13 via the coupling capacitor C1. The pulse generation circuit 13 then superimposes the pulses on the direct-current voltage of the battery. As such, the pulses on one hand could revitalize the battery during its recharge and, on the other hand, could enhance the ignition performance of the motor vehicle's engine, thereby achieving a better fuel efficiency.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A device for revitalizing a battery and enhancing ignition performance of a motor vehicle, comprising a pulse generation circuit, a frequency generation circuit, a voltage detection circuit, and a frequency control circuit; wherein
said battery has a positive terminal connected to said pulse generation circuit and voltage detection circuit, and a negative terminal connected to ground;
said pulse generation circuit is connected to said frequency generation circuit and said frequency control circuit, in addition to said positive terminal of said battery;
said frequency generation circuit is connected to said voltage detection circuit, said frequency control circuit, and said pulse generation circuit;
said voltage detection circuit is connected to said positive terminal of said battery, said frequency generation circuit, and said frequency control circuit; and
said frequency control circuit is connected to said voltage detection circuit, said frequency generation circuit, and said pulse generation circuit.

2. The device according to claim 1, wherein said pulse generation circuit contains resistors R1, R2, R4, and a triode Q1.

3. The device according to claim 1, wherein said frequency generation circuit contains an integrated circuit U1, and capacitors C1, C2.

4. The device according to claim 1, wherein said voltage detection circuit contains triodes Q2, Q3, a light emitting diode LED1, diodes D3, D4, resistors R5 to R8, R1 and capacitors C3, C4.

5. The device according to claim 1, wherein said frequency control circuit contains an integrated circuit U2, capacitors C5, C6, and resistors R9, R10.
